(19) United States
(12) Patent Application Publication
(10) Pub. No.: US 2021/0047812 A1
(43) Pub. Date: Feb. 18, 2021

(54) Fluid Dispensing Spraying Assembly

(71) Applicants: Michael Gallucci, West Palm Beach, FL (US); James J. La Penna, West Palm Beach, FL (US)

(72) Inventors: Michael Gallucci, West Palm Beach, FL (US); James J. La Penna, West Palm Beach, FL (US)

(21) Appl. No.: 16/540,957

(22) Filed: Aug. 14, 2019

(51) Int. Cl. E03C 1/046; B05B 1/18; B05B 7/24

(52) U.S. Cl. CPC E03C 1/046; B05B 7/2472; B05B 1/18

(57) ABSTRACT

A fluid dispensing spraying assembly for adding a fluid to a stream of water includes a conduit that is fluidically coupled to a water supply line. A spray head that is coupled to the conduit is in fluidic communication with the water supply line. A valve, which is Venturi type, is positioned inline with the conduit. A set of tubes that is operationally coupled to the valve is in fluidic communication with the valve. The valve is configured to generate a pressure in the set of tubes that is lower than a pressure in the conduit. Each of a set of reservoirs is selectively fluidically couplable to the valve via a respective tube so that a fluid that is positioned in the reservoir is drawn into the valve and sprayed through the spray head.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to spraying assemblies and more particularly pertains to a new spraying assembly for adding a fluid to a stream of water.

### (2) Description of Related Art Including Information Disclosed Under 37 CFR 1.97 and 1.98

The prior art relates to spraying assemblies.

### BRIEF SUMMARY OF THE INVENTION

An embodiment of the disclosure meets the needs presented above by generally comprising a conduit that is fluidically coupled to a water supply line. A spray head that is coupled to the conduit is in fluidic communication with the water supply line. A valve, which is Venturi type, is positioned inline with the conduit. A set of tubes that is operationally coupled to the valve is in fluidic communication with the valve. The valve is configured to generate a pressure in the set of tubes that is lower than a pressure in the conduit. Each of a set of reservoirs is selectively fluidically couplable to the valve via a respective tube so that a fluid that is positioned in the reservoir is drawn into the valve and sprayed through the spray head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a fluid dispensing spraying assembly according to an embodiment of the disclosure.

FIG. 2 is an isometric perspective view of an embodiment of the disclosure.

FIG. 3 is a bottom view of an embodiment of the disclosure.

FIG. 4 is a top view of an embodiment of the disclosure.

FIG. 5 is a cross-sectional view of an embodiment of the disclosure.

FIG. 6 is a side view of an embodiment of the disclosure.

### DETAILED DESCRIPTION OF THE INVENTION

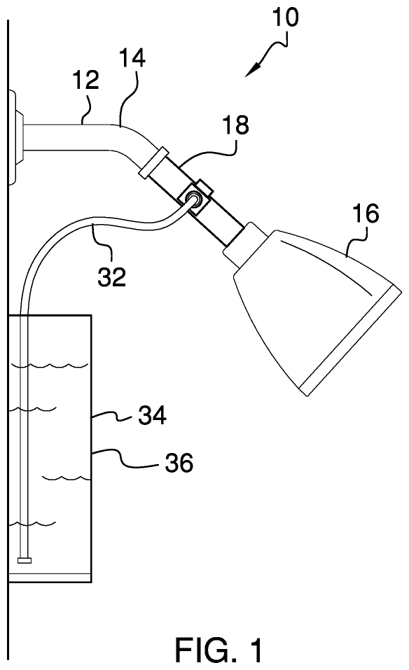

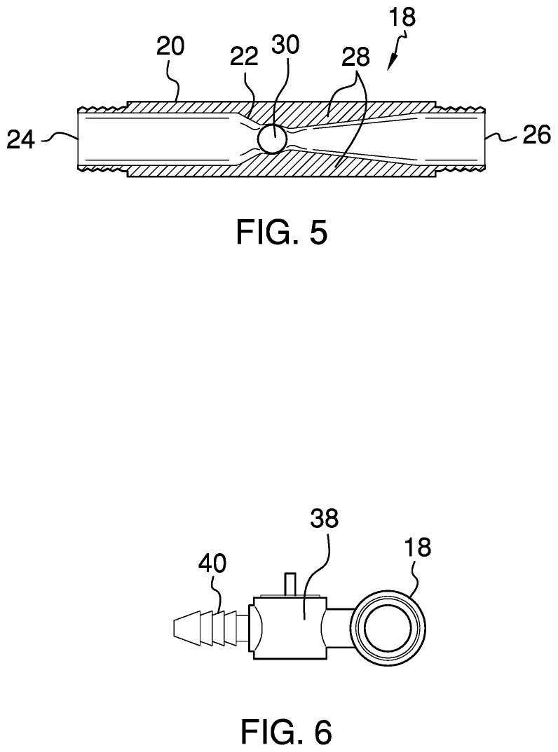

With reference now to the drawings, and in particular to FIGS. 1 through 6 thereof, a new spraying assembly embodying the principles and concepts of an embodiment of the disclosure and generally designated by the reference numeral 10 will be described.

As best illustrated in FIGS. 1 through 6, the fluid dispensing spraying assembly 10 generally comprises a conduit 12 that is fluidically coupled to a water supply line. The conduit 12 may comprise a water pipe 14 or other type of water pipeline, such as, but not limited to, plastic tubing, braided tubing, metal tubing, and the like.

A spray head 16 that is coupled to the conduit 12 is in fluidic communication with the water supply line. The spray head 16 may be shower type, or other type, such as, but not limited to, garden hose type, sink type, and the like.

A valve 18, which is Venturi type, is positioned inline with the conduit 12. The valve 18 comprises a pipe 20, as shown in FIG. 4. A constriction 22 is positioned in the pipe 20 substantially equally distant from a first end 24 and a second end 26 of the pipe 20. A taper 28 extends from the constriction 22 to the second end 26 of the pipe 20 so that the first end 24 and the second end 26 of the pipe 20 are substantially internally circumferentially equivalent. The valve 18 is configured to increase a velocity of water that flows through the pipe 20 from the first end 24 to the second end 26 to generate a low pressure proximate to the constriction 22. A hole 30 is positioned in the pipe 20 proximate to the constriction 22.

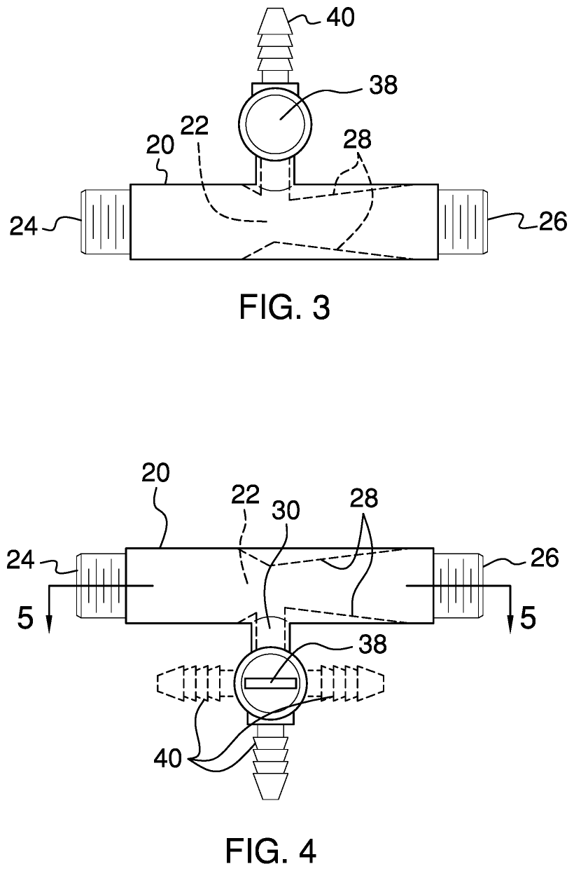

The pipe 20 may be externally threaded proximate to the first end 24 and the second end 26, as shown in FIG. 3, so that the first end 24 is positioned to be selectively threadedly coupled to the conduit 12 and so that the second end 26 is positioned to be selectively threadedly coupled to the spray head 16. The present invention anticipates other means for coupling the pipe 20 to the conduit 12 and the spray head 16, such as, but not limited to, quick connects, welds, and the like.

A set of tubes 32 that is operationally coupled to the valve 18 is in fluidic communication with the valve 18. The set of tubes 32 extends from the hole 30. The valve 18 is configured to generate a pressure in the set of tubes 32 that is lower than a pressure in the conduit 12.

Each of a set of reservoirs 34 is selectively fluidically couplable to the valve 18 via a respective tube 32 so that a fluid that is positioned in the reservoir 34, such as shampoo, conditioner, body wash, and cleaning fluid, is drawn into the valve 18 and sprayed through the spray head 16. The reservoirs 34 may be of any type, such as a wall attached container 36, as shown in FIG. 1, buckets, jugs, pails, and the like.

A regulator 38 is positioned inline between the set of tubes 32 and the valve 18. The regulator 38 is configured to selectively and fluidically couple a respective tube 32 of the set of tubes 32 to the valve 18 so that the fluid that is positioned in an associated reservoir 34 is drawn into the valve 18 through the respective tube 32 to mix with the water that flows through the valve 18 and then to be sprayed through the spray head 16.

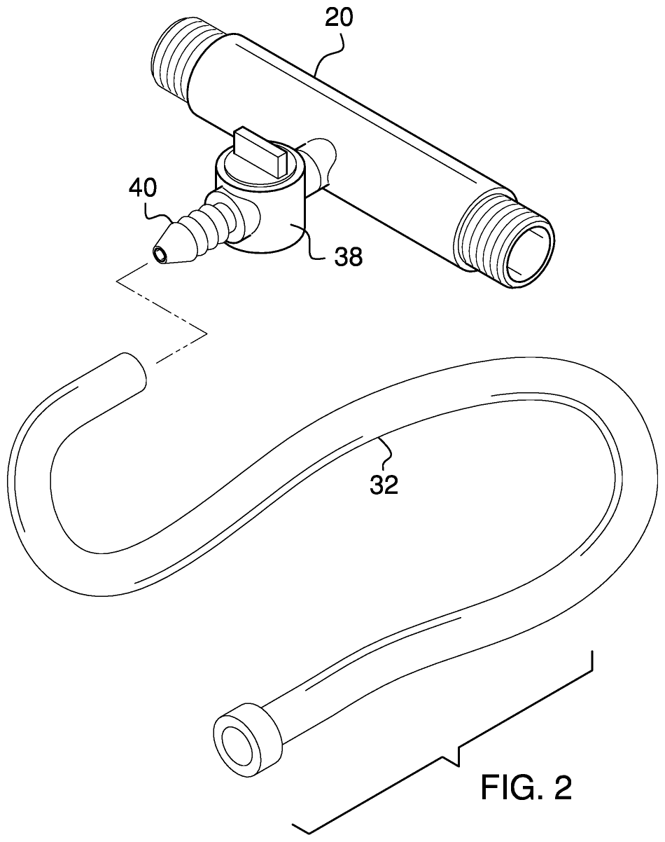

A set of connectors 40 is coupled to the regulator 38 so that each connector 40 is positioned to selectively couple to a respective tube 32 to removably and fluidically couple the respective tube 32 to the regulator 38. The set of connectors 40 comprises from one to four connectors 40. The set of connectors 40 may comprise three connectors 40, as shown in FIGS. 2-4. The set of connectors 40 also may comprise one connector 40, as shown in FIGS. 1 and 6. The connectors 40 may be hose barb type, as shown in FIGS. 2-4 and 6, or other connecting type, such as, but not limited to, quick connect type, hose clamp type, and the like.

In one example of use, tubes 32 are positioned singly in reservoirs 34 that comprise commercially available bottles of shampoo, conditioner, and body wash. A user would then use the regulator 38 to sequentially select the reservoirs 34 so that the shampoo, the conditioner, and the body wash are dispensed to wash and to condition hair of the user, and to wash the body of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A fluid dispensing spraying assembly comprising:
a conduit fluidically coupled to a water supply line;
a spray head coupled to the conduit such that the spray head is in fluidic communication with the water supply line;
a valve positioned inline with the conduit, the valve being Venturi type;
a set of tubes operationally coupled to the valve such that the set of tubes is in fluidic communication with the valve wherein the valve is configured for generating a pressure in the set of tubes that is lower than a pressure in the conduit; and
a set of reservoirs, each reservoir being selectively fluidically couplable to the valve via a respective tube such that a fluid positioned in the reservoir is drawn into the valve and sprayed through the spray head.

2. The assembly of claim 1, further comprising:
the conduit comprising a water pipe; and
the spray head being shower type.

3. The assembly of claim 1, further including the valve comprising:
a pipe;
a constriction positioned in the pipe substantially equally distant from a first end and a second end of the pipe;
a taper extending from the constriction to the second end of the pipe such that the first end and the second end of the pipe are substantially internally circumferentially equivalent wherein the valve is configured for increasing a velocity of water flowing through the pipe from the first end to the second end for generating the low pressure proximate to the constriction; and
a hole positioned in the pipe proximate to the constriction, the set of tubes extending from the hole.

4. The assembly of claim 3, further including the pipe being externally threaded proximate to the first end and the second end of the pipe such that the first end is positioned for selectively threadedly coupling to the conduit and such that the second end is positioned for selectively threadedly coupling to the spray head.

5. The assembly of claim 3, further including a regulator positioned inline between the set of tubes and the valve wherein the regulator is configured for selectively fluidically coupling a respective tube of the set of tubes to the valve such that the fluid positioned in an associated reservoir is drawn into the valve through the respective tube to mix with the water flowing through the valve and then to be sprayed through the spray head.

6. The assembly of claim 5, further including a set of connectors coupled to the regulator such that each connector is positioned for selectively coupling to a respective tube for removably fluidically coupling the respective tube to the regulator.

7. The assembly of claim 6, further including the set of connectors comprising from one to four connectors.

8. The assembly of claim 7, further including the set of connectors comprising three connectors.

9. The assembly of claim 7, further including the set of connectors comprising one connector.

10. The assembly of claim 7, further including the connectors being hose barb type.

11. A fluid dispensing spraying assembly comprising:
a conduit fluidically coupled to a water supply line, the conduit comprising a water pipe;
a spray head coupled to the conduit such that the spray head is in fluidic communication with the water supply line, the spray head being shower type;
a valve positioned inline with the conduit, the valve being Venturi type, the valve comprising:
a pipe, the pipe being externally threaded proximate to a first end and a second end of the pipe such that the first end is positioned for selectively threadedly coupling to the conduit and such that the second end is positioned for selectively threadedly coupling to the spray head,
a constriction positioned in the pipe substantially equally distant from the first end and the second end,
a taper extending from the constriction to the second end of the pipe such that the first end and the second end of the pipe are substantially internally circumferentially equivalent wherein the valve is configured for increasing a velocity of water flowing through the pipe from the first end to the second end for generating a low pressure proximate to the constriction, and
a hole positioned in the pipe proximate to the constriction;
a set of tubes operationally coupled to the valve such that the set of tubes is in fluidic communication with the valve wherein the valve is configured for generating a pressure in the set of tubes that is lower than a pressure in the conduit, the set of tubes extending from the hole;
a set of reservoirs, each reservoir being selectively fluidically couplable to the valve via a respective tube such that a fluid positioned in the reservoir is drawn into the valve and sprayed through the spray head;
a regulator positioned inline between the set of tubes and the valve wherein the regulator is configured for selectively fluidically coupling a respective tube of the set of tubes to the valve such that the fluid positioned in an associated reservoir is drawn into the valve through the respective tube to mix with the water flowing through the valve and then to be sprayed through the spray head; and
a set of connectors coupled to the regulator such that each connector is positioned for selectively coupling to a respective tube for removably fluidically coupling the respective tube to the regulator, the set of connectors comprising from one to four connectors, the set of connectors comprising three connectors, the set of connectors comprising one connector, the connectors being hose barb type.
